(19) United States
(12) Patent Application Publication
(10) Pub. No.: US 2025/0027638 A1
(43) Pub. Date: Jan. 23, 2025

(54) LIGHTED HEADGEAR

(71) Applicant: Waters Industries, Inc., West Dundee, IL (US)

(72) Inventor: Michael Waters, Aspen, CO (US)

(21) Appl. No.: 18/778,723

(22) Filed: Jul. 19, 2024

Related U.S. Application Data
(60) Provisional application No. 63/515,041, filed on Jul. 21, 2023.

(51) Int. Cl. F21V 23/04; F21L 14/00; F21V 21/084; F21Y 113/00

(52) U.S. Cl. CPC F21V 23/0492; F21L 14/00; F21V 21/084; F21V 23/045; F21Y 2113/00

(57) ABSTRACT

There is provided a dynamically activated headlamp for being worn on a user's head, the dynamically activated headlamp including a light module, a primary light source for directing light in a forward direction relative to the user's head, a plurality of peripheral light sources arranged about a periphery of the primary light source for directing light in corresponding peripheral directions relative to the user's head, and a motion sensor configured to detect movement of the user's head. The dynamically activated headlamp includes a controller to automatically activate one or more of the peripheral light sources in response to movement of the user's head detected by the motion sensor when the detected movement meets a predetermined light activation parameter, and automatically deactivate the one or more peripheral light sources in response to detection of a predetermined light deactivation parameter.

### CROSS-REFERENCE TO RELATED APPLICATION

This application claims the benefit under 35 U.S.C. § 119 (e) to U.S. Provisional Application No. 63/515,041, filed Jul. 21, 2023, entitled LIGHTED HEADGEAR, which is hereby incorporated by reference in its entirety.

### FIELD

This disclosure relates to lighting devices and, in particular, to lighted headgear.

### BACKGROUND

Often an individual desires a light source focused to illuminate an area while performing a task, or a light source directed in a general outward direction for visibility. Holding a flashlight is an option, but such lighting devices are often cumbersome and may detract from the task being completed because the flashlight must be held. As a result, hands-free lighting is often desired because the individual desiring illumination does not need to hold the light source. Common types of hands-free lighting include light sources mounted to headgear. Often, the light source is one or more light-emitting diodes (LEDs). The light source is typically oriented to provide light forwardly of the wearer so as to illuminate an area in the wearer's field of view. Such lighted headgear are convenient for hands-free lighting in a number of recreational activities, such as camping, hunting, fishing, jogging, or the like.

### BRIEF DESCRIPTION OF THE DRAWINGS

FIG. 1 is a front elevation view of lighted headgear shown as worn on the head of a user.

FIG. 2 is a front perspective view of the lighted headgear having a light module secured to a front mounting portion of a headband.

FIG. 3 is a rear perspective view of the lighted headgear showing ribs extending along a rear surface of the mounting portion.

FIG. 4 is a front perspective view of the lighted headgear showing the light module removed from the mounting portion and exposing a recessed cavity thereof sized for removably receiving a rear wall of the light module therein.

FIG. 5 is an exploded view of the light module showing internal components of the light module including a power source, circuit board, light reflector, and a housing assembly for housing the components therein.

FIG. 6A is a perspective view of the circuit board including LEDs supported on tabs bent out of plane from that of the circuit board.

FIG. 6B is a schematic view showing electrical components mounted on the circuit board including a processor, illumination sources, and various electrical components of the circuit board, and a recharging socket and battery electrically coupled to the circuit board.

FIG. 7A is a front elevation view of the light reflector showing petal portions each having walls that extend about a light opening.

FIG. 7B is a perspective view of the light reflector showing a central annular boss and petal portions extending radially therefrom.

FIG. 8 is a cross-sectional view taken along the line 6-6 of the light reflector of FIG. 5, including corresponding cross-sections of a lens member of a central light assembly and lens members of peripheral light assemblies showing peripheries of light spreads in dashed lines.

FIG. 9 is a cross-sectional view taken along the line 7-7 of the light reflector of FIG. 5, including corresponding cross-sections of the lens member of the central light assembly and lens members of peripheral light assemblies showing peripheries of light spreads in dashed lines.

FIG. 10 is a top plan view of the light module showing the overlap of the light spreads of left and right peripheral light assemblies with the light spread of the central light assembly.

FIG. 11 is a side elevation view of the light module showing the overlap of the light spreads of top and bottom peripheral assemblies with the light spread of the central light assembly.

FIG. 12 is a cross-sectional view taken along the line 10-10 of FIG. 2 showing a rim portion of the light module removably captured in an outer groove of the mounting portion.

FIG. 13 is a front perspective view of another lighted headgear having a light module secured to a headband.

FIG. 14 is a rear perspective view of the lighted headgear of FIG. 13 showing a padding and an adjustment mechanism for tightening the headband around a user's head.

FIG. 15 is a front perspective view of the lighted headgear of FIG. 13 showing hinge connections of a housing assembly of the light module and the headband.

FIG. 16 is a front elevation view of the light module showing a light transmissive housing cover member of the housing assembly having generally flat recessed portions between sloped wall portions that extend over light sources of the light module.

FIG. 17 is a top plan view of the light module showing mode switches of the housing body member.

FIG. 18 is a side elevation view of the light module showing a recharging port cover of the light module for covering an access opening to inhibit moisture or debris from entering a recharging socket in the housing assembly.

FIG. 19 is an exploded view of the light module showing internal components of the light module including a power source, circuit boards, and light reflector, and showing a housing body member and the housing cover member of the housing assembly for housing the components therein.

FIG. 20 is a schematic view showing electrical communications between a processor of the circuit board and a recharging socket, a battery, illumination sources, and various electrical components of the circuit board.

FIG. 21 is a perspective view of the circuit board including LEDs supported on tabs bent out of plane from that of the circuit board.

FIG. 22A is a front elevation view of the light reflector showing peripheral light reflector portions each having walls that extend about a light opening.

FIG. 22B is a perspective view of the light reflector showing a central annular boss and the peripheral light reflector portions extending radially therefrom.

FIG. 23 is an exploded view showing the light reflector and the housing cover member with light spreads formed by a central light assembly and peripheral light assemblies illustrated in dashed lines.

FIG. 24 is block diagram of an example peripheral light control flow chart for a headlamp.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures is combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Many headlamps illuminate a 60-degree field of view in front of a user. However, the visual field for humans, including mid- and far-peripheral vision, typically spans approximately 180 degrees of arc or more. Therefore, such headlamps fail to illuminate a user's peripheral vision. Wide field of view lamps, such as floodlamps, can be incorporated into headgear. However, floodlamps that utilize a constant-on wide field of view light source rapidly drain the battery power source or require an oversized battery that is not practical for lighted headgear.

In general, the lighted headgear described herein includes a light module having one or more peripheral light or illumination sources that are automatically activated by a controller based on detected movement of the light module, which, when the lighted headgear is being worn, corresponds to a detected movement of a wearer's head. In this way, peripheral lighting can be automatically and selectively (i) activated when it is detected that a wearer is turning their head and/or may benefit from increased peripheral lighting in a given direction, and (ii) deactivated when it is detected that the wearer is no longer turning their head or may not necessarily need increased peripheral lighting in the given direction. A user may select amongst various operational modes to instruct the controller such as a processor how to control the peripheral lights based on movement detected by a motion sensor assembly.

The one or more illumination sources include, for example, one or more LEDs. The headgear includes one or more power sources, which may be batteries such as rechargeable batteries (e.g., lithium-ion batteries). The lighted headgear includes battery charging interfaces for recharging rechargeable batteries. As used herein, a battery charging interface may be a fixed electrical interface such as a USB port that is electrically coupled to a rechargeable battery. In this way, a user may connect a power cable to the battery charging interface to recharge the rechargeable battery. The battery charging interface includes a removable cover that protects internal components of the light module from moisture and debris.

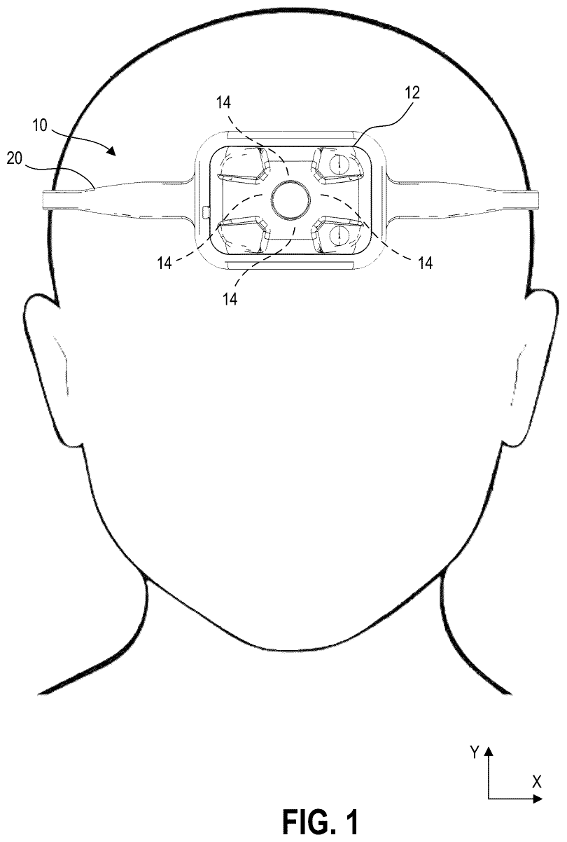

Referring to FIGS. 1, lighted headgear such as a headlamp 10 is shown. The headlamp 10 may be worn on a wearer's head such that a light module 12 of the headlamp 10 is secured against the wearer's forehead. In this way, one or more illumination sources 14 of the light module 12 provide light forwardly and to the periphery of the wearer so as to illuminate an area in the wearer's field of view.

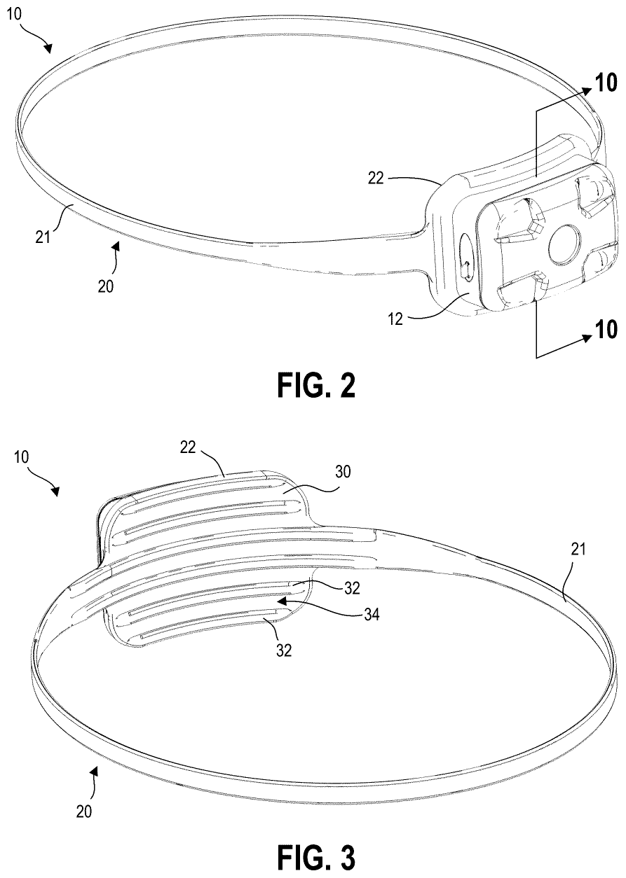

Referring to FIGS. 2-4, the headlamp 10 has a headband or head-fitting portion 20 that may be in the form of a flexible, elastic strap or band 21 of resilient material, such as a polymeric material or elastomeric material (e.g., silicone). The headlamp 10 also includes an enlarged mounting portion 22 that retains the light module 12. The band 21 has a narrow configuration while the mounting portion 22 is wider to be enlarged relative thereto. The mounting portion 22 may be integrally formed with the head-fitting portion 20 such that the mounting portion 22 and head-fitting portion 20 have a unitary (single-piece) construction so that the head fitting portion 20 or band 21 can be of the same material as the mounting portion 22. As discussed in greater detail below, the light module 12 may be removably secured to the mounting portion 22.

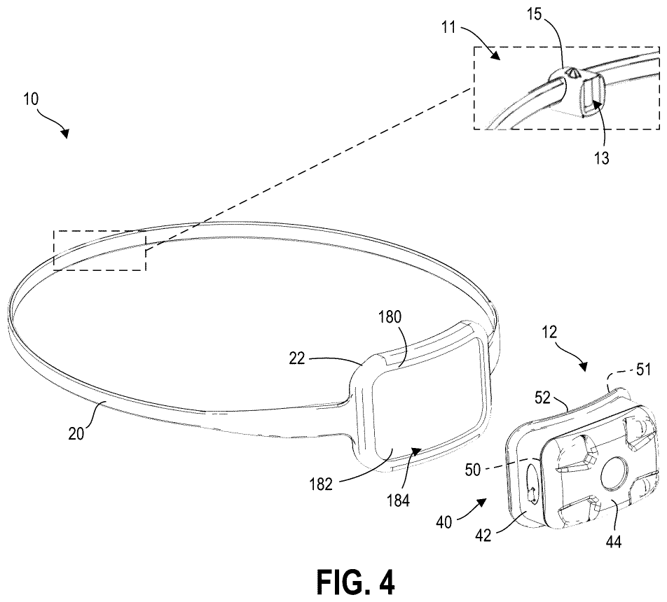

As shown in FIG. 4, the headlamp 10 may also include an adjustment mechanism 11 that allows a user to adjust the tension of the band 21 when worn. For example, a portion of the band 21 may be pulled through an opening 13 of a slide member 15 of the adjustment mechanism 11 that is slidingly mounted on the band 21. This decreases the length of the band 21 for tightening its fit on a user's head. Alternatively, pulling on the band 21 adjacent the slide member 15 will draw the portion pulled through the opening 13 back in the opposite direction to increase the length of the band 21 for loosening its fit on a user's head.

As shown in FIG. 3, the mounting portion 22 includes a rearwardly-facing surface 30 that is supported against a wearer's forehead when worn. The rearwardly-facing surface 30 may include one or more discontinuities such as raised ribs 32 that extend parallel to each other to form gaps or channels 34 therebetween. The ribs 32 may be generally contoured or curved to conform the forehead of the wearer. In this way, when the mounting portion 22 is pressed against a wearer's forehead, the ribs 32 permit air circulation through the channels 34, which may improve comfort by promoting airflow along the rearwardly-facing surface 30 and channeling perspiration away from the rearwardly-facing surface 30. Other surface discontinuities such as bumps or ridges may be provided to create spacing between the rearwardly-facing surface 30 and a wearer's skin. In other forms, the rearwardly-facing surface 30 is a generally smooth surface that does not include surface discontinuities.

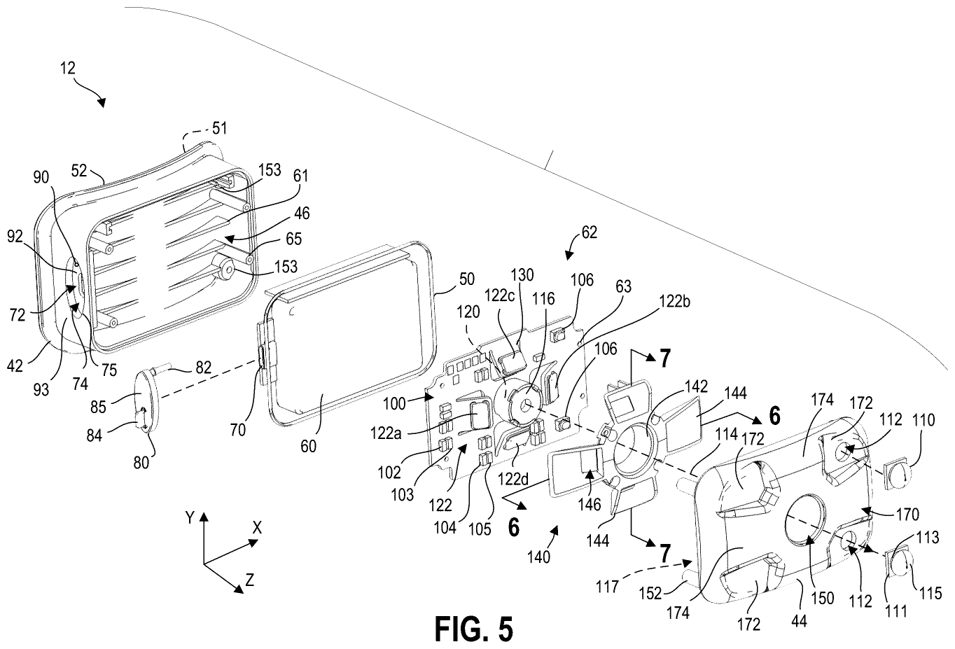

Referring to FIG. 4, the light module 12 includes a housing assembly 40 that includes a housing body member 42 and a cover member 44 so the housing assembly 40 has a two-part construction with the housing members 42 and 44 cooperating to enclose internal components of the light module 12 when the housing cover member 44 is secured to the housing body member 42. The housing cover member 44 preferably is formed of a light transmissive material such as a transparent or translucent material such that light emitted from the illumination sources 14 passes therethrough. The housing cover member 44 may be formed, for example, of a polycarbonate, polystyrene, or acrylic material. The housing body member 42 may be formed of acrylonitrile butadiene styrene. The light module 12 may include a seal 50 (shown in FIG. 5) such as a gasket or O-ring between the housing body member 42 and the housing cover member 44 to inhibit moisture or debris from entering into cavity 46 of the housing assembly 40. The housing body member 42 includes an arcuate rear wall 51 having an arcuate rearward rim or flange portion 52 extending laterally beyond and about sidewall portions of the housing body member 42 with the arcuate rear wall 51 and flange portion 52 thereof having a curvature that is similar to the curvature of a forehead. This arcuate configuration of the rear wall 51 and its rearward flange portion 52 may provide improved feel for a wearer as compared to a light module having a planar rearward facing surface.

Referring to FIG. 5, the housing assembly 40 houses various internal components of the light module 12 within the cavity 46, such as the illumination sources 14, a power source 60 for energizing the illumination sources 14, and a circuit board 62. The circuit board 62, which may be a printed circuit board (PCB), is electrically coupled to the power source 60 and the illumination sources 14 to control the operational state (e.g., on/off) of the illumination sources 14 via a user-operated actuator, as described hereinafter.

In the illustrated and preferred form, the power source 60 is a rechargeable (e.g., lithium-ion) battery. The power source 60 may be seated on a support structure of the housing body member 42 such as ribs 61 (as shown in FIG. 5.). In other approaches, the power source 60 may be a non-rechargeable, replaceable battery such as a cylindrical battery, coin cell battery, or the like. Although a single power source 60 is shown, more than one power source may be provided.

The light module 12 includes a recharging socket 70 that is operably coupled to the power source 60 and that is configured to receive a charging plug for providing charging power for charging the power source 60. The recharging socket 70 may include, for example, a universal serial bus (USB) interface that receives power from an external source through a USB charging cable having a plug for being received in the recharging socket 70. The USB interface may be a USB-A, USB-B, USB-C, USB, micro USB, or mini USB interface. Other suitable recharging interfaces such as Firewire, Lightning connector, or Ethernet interfaces may be used.

The recharging socket 70 is disposed within the cavity 46 of the housing assembly 40 in alignment with an access opening 72 of the housing body member 42. In this way, a power supply can be inserted through the access opening 72 to engage the recharging socket 70 and provide power through the recharging socket 70 and to the power source 60.

In one approach, the access opening 72 is centered in an external recessed portion 74 of one of the sidewall portions 75 of housing body member 42. The light module 12 may include a cover or cap 80 that is removably secured relative to the housing body member 42. For example, an arm 82 of the cap 80 may be retained by an aperture 90 through a recessed wall 92 of the external recessed portion 74 of the housing body member 42. The cap 80 may be sized such that, when in the closed or covered position, the cap 80 is retained with a plug fit within the external recessed portion 74 and covers access opening 72 to inhibit moisture or debris from entering the recharging socket 70 or cavity 46 of the housing assembly 40. More particularly, with the cap 80 in the closed or covered position, the cap 80 forms a press-fit engagement with the external recessed portion 74 of the housing body member 42. In this position, the exterior-facing surface 85 of the cap 80 may be substantially flush with the exterior surface of the housing body sidewall portion 93, except at pull-tab 84 which projects outwardly of the cap surface 85. To access the recharging socket 70 and recharge the power source 60, a user may pull on pull-tab 84 to remove the cap 80 from the external recessed portion 74, and then may turn the cap 80 by rotating the arm 82 in the aperture 90. When the cap 80 is turned to the open or uncovered position, the arm 82 keeps the cap 80 connected relative to the housing body member 42 such that both of the user's hands are free to insert a charging plug into the recharging socket 70.

As discussed, the light module 12 includes a circuit board 62 within the housing assembly 40. The circuit board 62 is secured to the housing body member 42 via fasteners (not shown) at holes 63 that are aligned with apertured posts 65 of the housing body member 42.

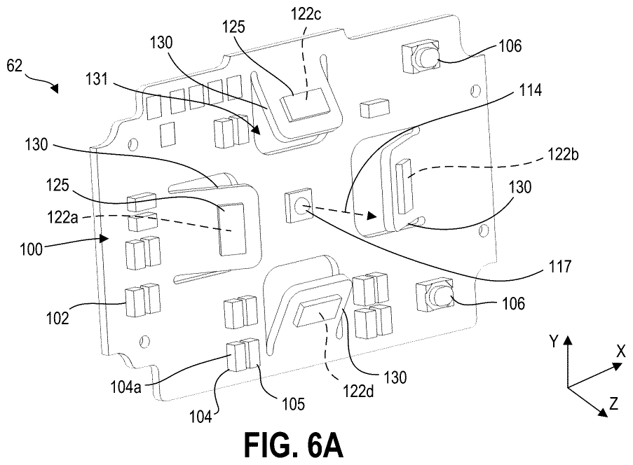

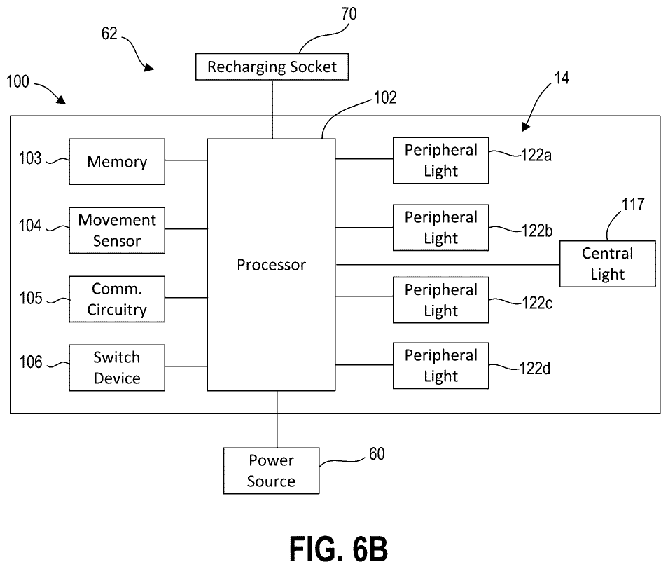

Referring to FIGS. 6A and 6B, the circuit board 62 includes electrical circuitry 100 such as a processor 102, a memory 103 (e.g., a programmable, non-transitory computer-readable random-access memory), a motion or movement sensor assembly 104, communication circuitry 105, and one or more switch devices 106 for controlling operation of the illumination sources 14. As shown in FIG. 6B, the processor 102 is in electrical communication with the electrical circuitry 100, as will be described more fully hereinafter. The processor 102 is also in electrical communication with one or more illumination sources 14 such as central LED 117 and peripheral light assemblies 122a, 122b, 122c, 122d. Although shown on a single circuit board 62, one or more components of the electrical circuitry 100 and the illumination sources 14 may be provided on separate circuit boards that may be electrically coupled. The electrical circuitry 100 may be electrically interconnected, for example, by printed conductive traces, wires, or combination thereof.

The processor 102 is also in electrical communication with the power source 60 such that the processor 102 is informed of a charge level of the power source 60. The processor 102 is also in electrical communication with the recharging socket 70 such that processor 102 can selectively inhibit or permit charging of the power source 60 via the recharging socket 70 based on a known charge level of the power source 60. For example, when the charge level of the power source 60 is below a predetermined threshold (e.g., 95% or 100% of full capacity), the processor 102 may permit charging of the power source 60 via the recharging socket 70 when the recharging socket 70 receives a plug of a charging cable connected to a power supply. When the charge level of the power source 60 achieves or exceeds a predetermined threshold (e.g., 95% or 100% of full capacity), the processor 102 may inhibit charging of the power source 60 even when the recharging socket 70 receives a charging cable connected to a power supply.

The processor 102 is also in electrical communication with the motion or movement sensor assembly 104 such that motion of movement detected by the movement sensor assembly 104 is relayed to the processor 102. The movement sensor assembly 104 may include one or more of a gyroscope, an accelerometer, and a location sensor (e.g., Global Positioning System (GPS)). In this way, the movement sensor assembly 104 can determine one or more of an orientation (including a static orientation and/or a change in orientation), acceleration, speed, and location (including a static location and/or a change in location) of the light module 12, as discussed in greater detail below. Such determined orientations, accelerations, speed, and locations may inform the processor 102 as to the current or expected position and orientation of the wearer's head such that the processor 102 may activate additional lighting in the direction of the wearer's head movement to provide enhanced lighted peripheral vision, as discussed herein.

The processor 102 is also in electrical communication with the communication circuitry 105. The communication circuitry 105 may include a receiver, a transmitter, and/or a transceiver. The communication circuitry 105 may be configured to communicate wirelessly via one or more approaches such as Bluetooth®. In other approaches, the communication circuitry 105 may be configured to communicate over radio frequency or Wi-Fi (e.g., to a local wireless network or the internet). The communication circuitry 105 is configured to receive information such as operational updates such that the processor 102 may update or otherwise revise the programming stored on the memory 103 as received by the communication circuitry 105. Example updates may include revised sensitivity thresholds, discussed in greater detail herein.

The processor 102 is also in electrical communication with one or more switch devices 106. The switch devices 106 may be push button or plunger-style switch devices, and may be normally-open contact switches. Switch covers 110 are aligned with and extend above the switch devices 106 and protrude through apertures 112 in the housing cover member 44, as will be described more fully hereinafter. The switch covers 110 may be resilient buttons formed, for example, of silicone. As the switch devices 106 are operably coupled to the illumination sources 14, when a user presses on a switch cover 110, the switch cover 110 actuates the switch device 106 to change a mode of the light module 12 (e.g., on, off, a brightness level, or a peripheral illumination mode, as discussed in greater detail below). Other switch devices such as a slide switch, a toggle switch, or a rotary switch may be used instead of or in addition to switch device 106. Although two switch devices 106 are shown, a single switch device or three or more switch devices may be provided.

The illumination sources 14 include a primary or central light assembly 120 and one or more peripheral light assemblies 122. The peripheral light assemblies 122 include lights, light sources, or LEDs 122a, 122b, 122c, 122d, which may emit light spreads of approximately 120-180 degree, and LED covers 125 that extend over to cover the LEDs 122a, 122b, 122c, 122d. As shown in FIG. 6A, the LED covers 125 may be in the form of flat-top LED covers.

As shown in FIGS. 5 and 6A, the central light assembly 120 includes a central light, light source, or LED 117 oriented to project light along central axis 114 thereof in a forward direction, to illuminate a front field of view of a user when in operation and being worn on the user's head or forehead, as shown in FIG. 1. The central LED 117 has a lens member 116 extending thereover. The LED 117 and lens member 116 may be configured to focus the light emitted from the central LED 117 to an approximately 60-degree spread or angle of view in front of the wearer. As used herein, a light spread refers to a spread of light emanated from a light source and generally corresponds to the viewing angle. In some instances, the light spread may be in the form of a light cone. The light spread emitted from the light source may be unobstructed (e.g., such that the light spread is generally rectangular or conical from the light source) or may be focused (e.g., via one or more walls or guides, as discussed herein). The central LED 117 may have a default or set mode of brightness that is brighter than peripheral LEDs 122a, 122b, 122c, 122d of the peripheral light assemblies 122. In this way, battery power may be allocated primarily to the brighter central LED 117 to illuminate a wearer's primary, forward field of view, and selectively applied to the peripheral LEDs 122a, 122b, 122c, 122d (based on a detected or predicted direction of the wearer's head movement, as discussed herein) to conserve battery power.

One or more of the LEDs of the peripheral light assemblies 122 is automatically selected to turn on and off based on head movement or orientation of the wearer detected by the motion sensor assembly 104, as discussed in greater detail below. The peripheral light assemblies 122 are arranged around the perimeter of the central light assembly 120. As illustrated, a first peripheral light or LED 122a may be arranged at a first lateral side of the central light assembly 120, and a second peripheral light or LED 122b may be arranged at a second lateral side of the central light assembly 120 opposite the first peripheral light 122a. A third peripheral light or LED 122c may be arranged at an upper side of the central light assembly 120, and a fourth peripheral light or LED 122d may be arranged at a lower side of the central light assembly 120 opposite the third peripheral light 122c.

The peripheral light assemblies 122 may be mounted on tabs 130 of the circuit board 62 that are bent or inclined away from the circuit board 62 to form openings 131 in the circuit board 62 under the tabs 130. The tabs 130 are bent to form oblique angles with the plane of the circuit board 62 such that peripheral light assemblies 122 project light along an axes 123a, 123b, 123c, 123d that extend at oblique angles outwardly away from the forward direction toward a peripheral direction. For example, the tabs 130 may be bent at an angle of approximately 30 degrees relative to a plane of the circuit board 62 that extends orthogonal to the central axis 114. As discussed in greater detail below, when a peripheral light assembly 122 is illuminated, light is projected by the peripheral light assembly 122 into the peripheral view of the wearer, thereby expanding the wearer's illuminated field of view, useful when encountering low lit or unlit environments.

In use, a wearer may select one or more modes of the light module 12 by pressing a switch cover 110 to actuate a corresponding switch device 106. For example, a first switch device 106 may control the central light assembly 120, and may cycle between one or more modes such as “on,” “off,” and a brightness level (“high,” “medium,” “low”). A second switch device 106 may turn a “peripheral illumination mode” on or off.

In the peripheral illumination mode, the processor 102 determines which, if any, of the peripheral light assemblies 122 to illuminate based on information about the wearer's head, as detected by the motion sensor assembly 104. For example, if a gyroscope 104a of the motion sensor assembly 104 detects the light module 12 is being rotated in a horizontal direction to the right, the processor 102 will activate the corresponding right peripheral light source 122a located on the right lateral side of the central light assembly 107. For example, when a gyroscope of the motion sensor assembly 104 detects the light module 12 is being rotated in the “Direction of Movement” of Table 1 below, the processor 102 may activate the peripheral light assemblies 122 according to the following:

TABLE 1

| Direction of Movement | Peripheral Lights (PL) Activated |
|---|---|
| Left | PL 122b |
| Right | PL 122a |
| Up | PL 122c |
| Down | PL 122d |
| Left and Up | PL 122b, PL 122c |
| Right and Up | PL 122a, PL 122c |
| Left and Down | PL 122b, PL 122d |
| Right and Down | PL 122a, PL 122d |

The processor 102 may similarly utilize information received from other sensors of the motion sensor assembly 104 to determine if any one or more of the peripheral lights 122a, 122b, 122c, 122d is to be automatically activated or deactivated. For example, the processor 102 may only activate one or more of the peripheral lights 122a, 122b, 122c, 122d according to Table 1 if an accelerometer of the motion sensor assembly 104 also detects a threshold acceleration of the light module 12. Threshold accelerations may be programed and stored in the memory 103. In this way, the processor 102 may disregard a gradual glance of the wearers head in a given direction where the acceleration of the user's head as it moves does not reach the threshold acceleration.

The processor 102 may also or instead utilize information received from the GPS to determine whether to activate one or more of the peripheral light assemblies 122. For example, when a user is operating a vehicle such as a car, motorcycle, or bike, the GPS may detect when the vehicle is making a turn. Upon the GPS determining the vehicle is turning to the left, for example, the processor 102 may illuminate left peripheral light 122b. Similarly, upon the GPS determining the vehicle is turning to the right, the processor 102 may illuminate right peripheral light 122a. Once the GPS detects that the turn is complete and the vehicle is traveling straight ahead, the processor 102 can deactivate the activated peripheral light 122a-122d so that, for example, only the central light 117 is activated. In this way, peripheral lighting can be automatically and selectively activated to illuminate in the direction of travel.

In one approach, a wearer may select “sub” modes when the “peripheral illumination mode” is selected. Such sub-modes may correspond to a type or level of activity, as selected by the user. Upon selection of a sub-mode, the processor 102 adjusts a threshold acceleration, as detected by the motion sensor assembly 104, for activating one or more of the peripheral light assemblies 122. Example sub-modes include a running sub-mode (in which the wearer's head is expected to move quickly the in the left/right/up/down directions relative to the forward direction along central axis 114), and a walking sub-mode (in which the wearer's head is not expected to move as quickly in such directions). In the running sub-mode, the threshold acceleration is higher as compared to the threshold acceleration in the walking sub-mode. In this way, the processor 102 may disregard certain head movements while in the running sub-mode, but activate one or more of the peripheral light assemblies 122 based on the same head movements while in the walking sub-mode.

In another example approach, a wearer may select “timed” modes of the “peripheral illumination mode.” In such timed modes, the processor 102 ignores signals from the motion sensor assembly 104 until such signals are received over a predetermined period of time. For example, a wearer may select a “Mode” having a “Time Threshold” according to Table 2 below, only after which time the Threshold is achieved will the processor 102 activate a peripheral light 122a, 122b, 122c, 122d (e.g., pursuant to receiving signals indicating an orientation according to Table 1 above):

TABLE 2

| Mode | Time Threshold | |
|---|---|---|
| 1 | 0.001 | seconds |
| 2 | 0.01 | seconds |
| 3 | 0.1 | second |
| 4 | 0.25 | seconds |
| 5 | 0.5 | seconds |
| 6 | 1 | second |

In another approach, the processor 102 may deactivate and activated peripheral light 122a, 122b, 122c, 122d automatically after a predetermined (or user selected) period of time. For example, if a wearer turns their head to the left and the processor 102 activates left peripheral light 122b, the processor 102 may then automatically deactivate the left peripheral light 122b after determining (via the gyroscope 104a of the motion sensor assembly 104) that the wearer has not rotated their head for a period of time, such as 5 seconds, 10 seconds, 30 seconds, 60 seconds, or a time threshold longer than 60 seconds. In some approaches, the processor 102 may deactivate a first peripheral light while keeping a second peripheral light activated. For example, if a wearer stops rotating their head in an upward direction after 1 second but continues to rotate their head to the right after 1 second while the light module is operating in Mode 3 of Table 2 above, the processor 102 may deactivate upper peripheral light 122c while keeping right peripheral light 122a activated.

In another approach, a wearer may select a given peripheral light 122a, 122b, 122c, 122d to turn on and remain on until the wearer deactivates the peripheral light.

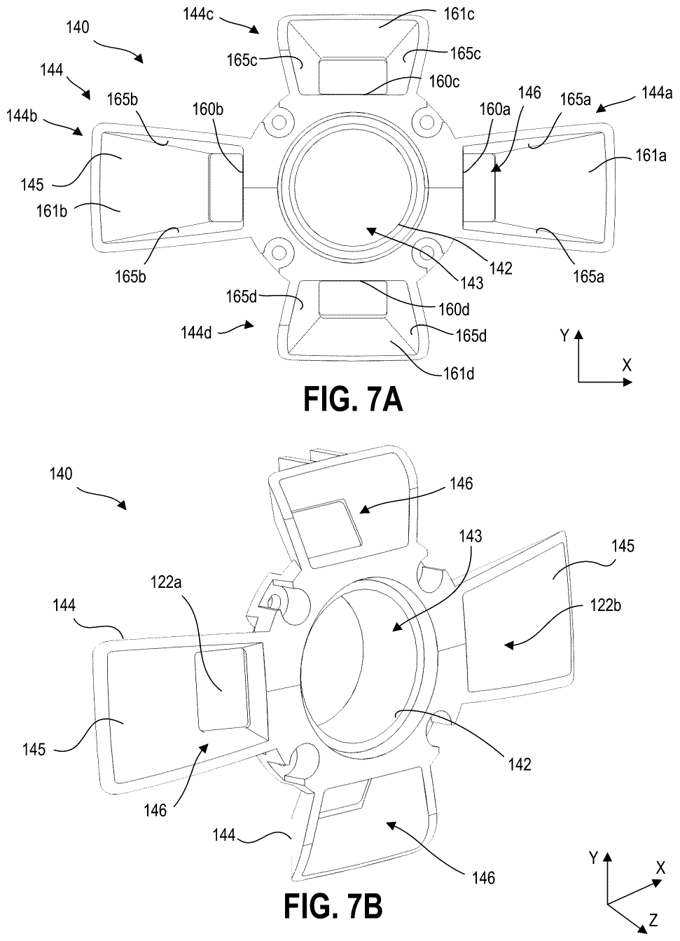

Referring to FIGS. 7A and 7B, the light module 12 may further include a light reflector 140 that directs light from the peripheral light assemblies 122 in peripheral directions relative to the central light spread 120a directed in the forward direction along central axis 114 by the central light assembly 120. The light reflector 140 may be formed, for example, of acrylonitrile butadiene styrene (ABS) plastic and is coated (e.g., via electroplating) with a reflective material (e.g., silver, platinum, nickel, chrome, or combination thereof) that directs emitted light into the above-described fields of view.

The light reflector 140 includes a central annular boss 142 that receives the lens member 116 of the central light assembly 120 so that the annular boss 142 is part of the central light assembly 120 and such that light emitted from the central LED 117 travels through a central opening 143 of the annular boss 142 of the light reflector 140 and through an aligned central window 150 of the housing cover member 44. The light reflector 140 also includes peripheral petal portions 144 that extend radially from the central boss 142 which are part of the corresponding peripheral light assemblies 122. Thus, the number and positioning of the petals 144 corresponds to the number and positioning of the peripheral light assemblies 122.

Each petal portion 144 includes walls 145 extending about an opening 146 that is aligned with a corresponding peripheral light source 122a, 122b, 122c, and 122d. For example, petal portions 144a, 144b, 144c, and 144d are aligned with peripheral light sources 122a, 122b, 122c, and 122d, respectively, with each peripheral light source 122a, 122b, 122c, and 122d having a central axis 123a, 123b, 123c, 123d. The petal portions 144 of the light reflector 140 include radially inner guide or reflector surfaces and radially outer guide or reflector surfaces along with interconnecting side surfaces that form light spreads that direct light in generally forward and peripheral directions.

More particularly, lateral left and right petal portions 144a and 144b have generally forwardly-directed radially inner reflector surfaces 160a, 160b that reflect light emitted from the peripheral light sources 122a, 122b toward the lateral left and right directions, respectively. The left and right petal portions 144a and 144b also have generally radially-directed outer reflector surfaces 161a, 161b, and opposing upper and lower side surfaces 165a, 165b that interconnect the respective inner and outer reflector surfaces 160a, 160b, and 161a, 161b. Upper and lower petal portions 144c and 144d have generally forwardly-directed radially inner reflector surfaces 160c, 160d that reflect light emitted from the peripheral light sources 122c, 122d toward the upper and lower directions, respectively. Upper petal portion 144c has a generally upwardly-directed radially outer reflector surface 161c, and lower petal portion 144d has a generally downwardly-directed radially outer reflector surface 161d. Upper and lower petal portions 144c and 144d further have opposing lateral side surfaces 165c, 165d that interconnect the respective inner and outer reflector surfaces 160c, 160d, and 161c, 161d. The reflector surfaces cooperate to form peripheral light spreads, as discussed in greater detail below.

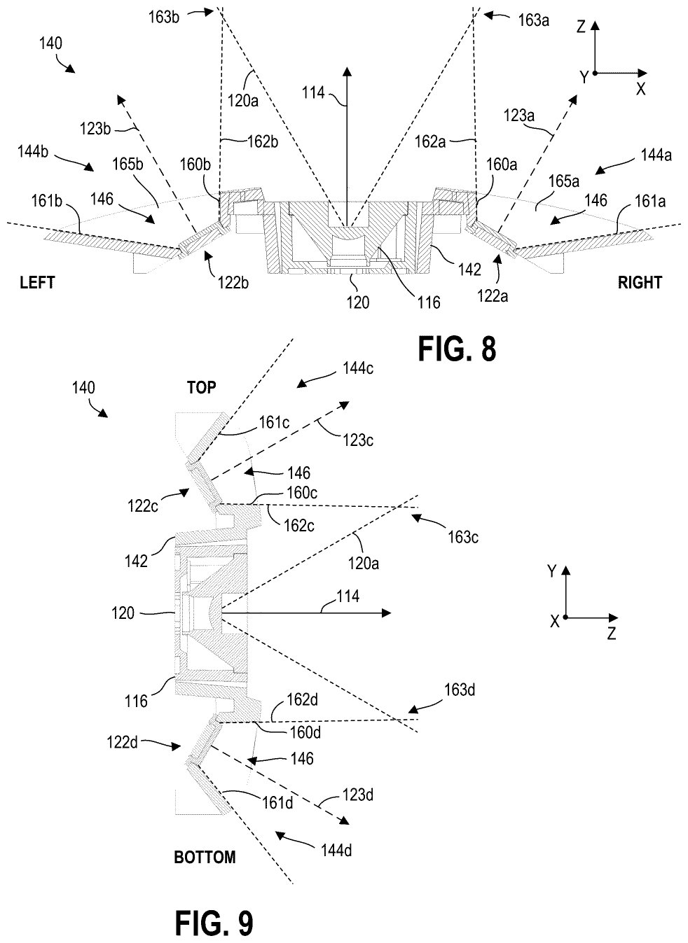

Referring to FIG. 8, the generally forwardly-directed radially inner reflector surfaces 160a, 160b and generally radially-directed outer reflector surfaces 161a, 161b of the lateral left and right petal portions 144a and 144b cooperate to form inner and outer reflector guides for light of right and left peripheral light spreads 162a, 162b generated by the light emitted from corresponding right and left light sources 122a, 122b. The inner reflector surfaces 160a, 160b are oriented to reflect light away from the central axis 114 and in the direction of the wearer's right and left peripheral vision, respectively. Inner reflector surfaces 160a, 160b may be generally parallel to a forward axis Z, or may be slightly angled relative to the forward Z axis toward a lateral axis X. In the illustrated form, the inner reflector surfaces 160a, 160b are canted or angled inwardly toward each other and the central axis 114 by one degree. As can be seen, light from the peripheral light sources 122a, 122b overlaps light 120a projected from the central light assembly 120 generally forward of the wearer, as indicated at 163a, 163b in FIG. 8.

Outer reflector surfaces 161a, 161b may be generally parallel to the X axis, or may be angled relative to the X axis toward the central axis 114. In the illustrated form, the outer reflector surfaces 161a, 161b are angularly offset from the X axis by approximately 8.5 degrees to extend between the X and Z axes. In this way, light that would otherwise be cast directly to the side of the wearer (i.e., outside of the peripheral view of the wearer) is instead directed into the peripheral view of the wearer.

The side surfaces 165a, 165b of the left and right petal portions 144a and 144b are shaped to guide stray light, as by reflecting” in the direction of the wearer's right and left peripheral vision, respectively. The side surfaces 165a, 165b may taper away from each other along two different axes. For example, the side surfaces 165a, 165b may taper away along the X axis as the petal portions 144a, 144b extend away from the central axis 114. The side surfaces 165a, 165b may also taper away along the Z axis in the rear to forward direction. In this way, when the processor 102 detects sufficient movement of the wearer's head in a lateral direction and activates the corresponding peripheral light 122a or 122b, the side surfaces 165a, 165b focus light in the lateral direction and limit the vertical spread of light.

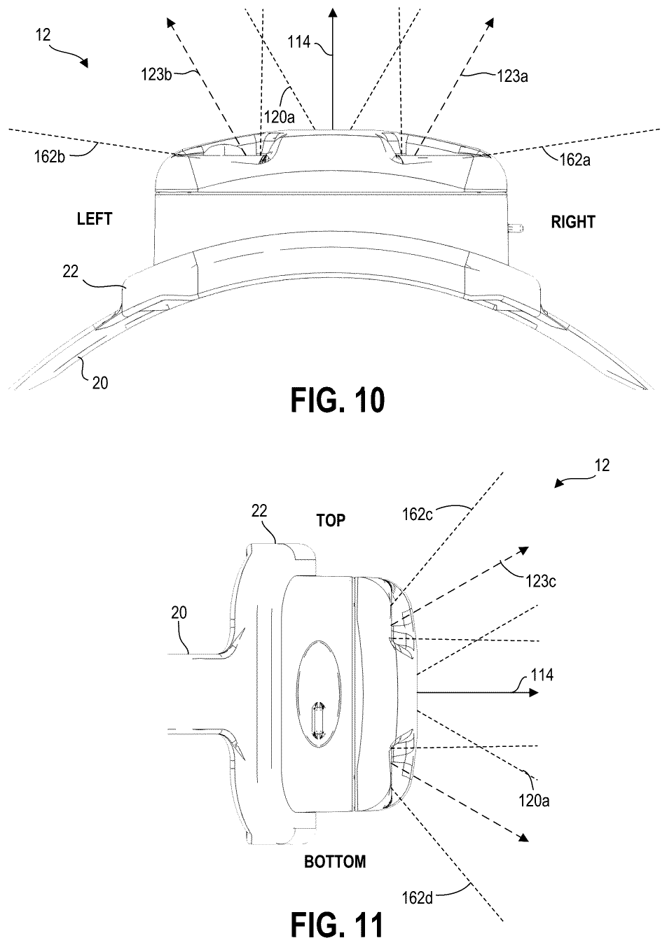

The light reflector 140 therefore provides, in addition to the forward illuminated field of view (as illuminated by light source 120a of the central light assembly 120), an illuminated lateral peripheral field of view to the right of the wearer when peripheral light 122a is illuminated, and an illuminated lateral peripheral field of view to the left of the wearer when peripheral light 122b is illuminated, thereby enhancing visibility in the wearer's lateral peripheral fields of view. Example resulting illuminated lateral fields of view with the light reflector 140 installed in the light module 12 are shown in FIG. 10.

Referring to FIG. 9, the inner reflector surfaces 160c, 160d are oriented to reflect light away from the central axis 114 and in the direction of the wearer's upper and lower peripheral vision, respectively. Similar to inner reflector surfaces 160a and 160b, upper and lower inner reflector surfaces 160c, 160d may be generally parallel to the forward axis Z, or may be slightly angled relative to the Z axis. In the illustrated form, the inner reflector surfaces 160c, 160d are angled inwardly toward each other and the central axis 114 by one degree. As can be seen, light spreads emitted from the peripheral light sources 122c, 122d overlap the light spread 120a projected from the central light assembly 120 generally forward of the wearer, as indicated at 163c, 163d.

Radially outer reflector surfaces 161c, 161d may be generally parallel to the vertical Y axis, or may be angled relative to the Y axis to extend between the Y and Z axes. In the illustrated form, the outer reflector surfaces 161c, 161d are angularly offset from the Y axis toward the Z axis by approximately 38 degrees. The inclines of the outer reflector surfaces 161c, 161d are steeper (i.e., have a greater incline toward the Z axis) than the inclines of the outer reflector surfaces 161a, 161b of the lateral petal portions 144a and 144b. This is because a human eye has reduced upward and downward peripheral vision as compared to the lateral peripheral vision of a human eye. As such, the outer reflector surfaces 161c, 161d of the upper and lower petal portions 144c and 144d may have a steeper incline to direct a greater amount of peripheral light generally forward of the wearer rather than upwardly.

The side surfaces 165c, 165d of the upper and lower petal portions 144c and 144d are shaped to guide stray light in the direction of the wearer's upper and lower peripheral vision, respectively. The side surfaces 165c, 165d may taper away from each other along two different axes. For example, the side surfaces 165c, 165d may taper away along the Y axis as the petal portions 144c, 144d extend away from the central axis 114. The side surfaces 165c, 165d may also taper away along the Z axis in the rear to forward direction. In this way, when the processor 102 detects sufficient movement of the wearer's head in an upward or downward direction and activates the corresponding peripheral light 122c, 122d, the side surfaces 165c, 165d focus light in the upward or downward direction and limit the lateral spread of light.

The light reflector 140 therefore provides, in addition to the forward illuminated field of view (as illuminated by light 120a of the central light assembly 120), an illuminated peripheral field of view above the wearer when peripheral light 122c is illuminated, and an illuminated peripheral field of view below the wearer when peripheral light 122d is illuminated, thereby enhancing visibility in the wearer's upper and lower peripheral fields of view, respectively. Example resulting illuminated upward and downward fields of view with the light reflector 140 installed in the light module 12 are shown in FIG. 11.

Referring again to FIG. 5, the housing cover member 44 may be secured to the housing body member 42 via fasteners (not shown) to secure the above-described components within the cavity 46 of the housing assembly 40. More particularly, the housing cover member 44 includes apertured posts 152 that are aligned with posts 153 of the housing body member 42. The posts 153 of the housing body member 42 have through bores extend through the rear wall 51 and open to outer surface thereof such that fasteners may be received in the bores to project through the rear wall 51 and be received in apertures of the apertured posts 152 to fasten the housing cover member 44 to the housing body member 42.

The forward wall 170 of the housing cover member 44 includes generally flat cover portions 172 at the corner regions of the housing cover member 44 between adjacent peripheral light assemblies 122. One or more of the flat cover portions 172 each include an aperture 112 that extends therethrough for receiving switch cover 110 which, as discussed, are operable to actuate corresponding switch device 106 mounted to the circuit board 62. More particularly, switch covers 110 include a base portion 111, a narrowed ceiling groove or neck portion 113 extending up from the base portion 111, and a head portion 115 that is enlarged relative to the neck portion 113 connected thereto. In this manner, the switch covers 110 each have a mounting groove that extends about the neck portion 113 for receiving the cover portion 172 extending about the aperture 112 in the mounting groove which secures the switch cover 110 to the cover portion 172. With the switch covers 110 secured to the housing cover member 44, the base portion 111 extends along an interior surface 117 of the housing cover member 44, the neck portion 113 extends through the aperture 112 of the forward wall 170, and the head portion 115 is disposed at the exterior surface of the forward wall 170.

The forward wall 170 of the housing cover member 44 includes translucent window portions 174 that extend radially from the central window 150 between the flat cover corner portions 172. The peripheral window portions 174 extend above the petal portions 144 of the light reflector 140 to shield the petal portions 144 and peripheral LEDs 122 while still permitting light emitted from the LEDs 122 to travel therethrough. The peripheral window portions 174 are raised relative to the flat cover portions 172 and may have a shape and slope that generally matches the underlying petal portion 144. In this way, the peripheral window portions may have a first height adjacent the central window 150, and may taper downwardly as the peripheral window portion 174 extends radially away from the central window 150. The peripheral window portions 174 may also taper outwardly as they extend away from the central window 150. More particularly, lateral peripheral window portions 174 taper outwardly from the X axis as they extend away from the central window 150, and upper and lower lateral peripheral window portions 174 taper outwardly from the Y axis as they extend away from the central window 150, consistent with the outward tapering of the side surfaces 165a, 165b, 165c, 165d of the light reflector 140.

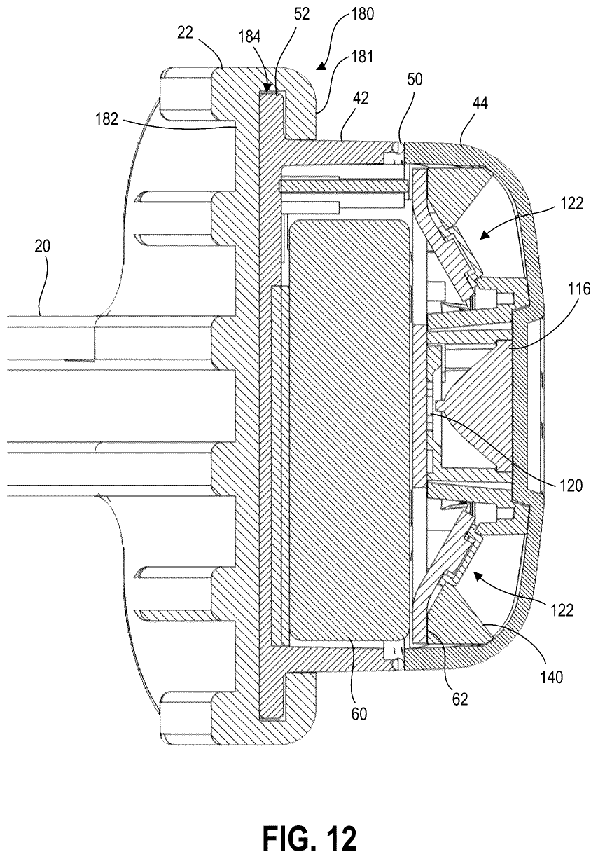

Referring to FIGS. 5 and 12, the light module 12 is removably secured to the head-fitting portion 20. More particularly, the arcuate rearward rim portion 52 of the light module 12 may be removably secured to the mounting portion 22 of the head-fitting portion 20. The mounting portion 22 includes a generally inwardly-extending peripheral rim portion 180 that has an overhang lip portion 181 that extends over and is spaced from a rear wall 182 of the mounting portion 22 to form a groove 184 of the mounting portion 22 in which the rim portion 52 is removably received. The mounting portion 22 is formed of a shape-retentive material that is more flexible than the housing body member 42 and that is capable of resiliently flexing when a user pulls the light module 12 away from the mounting portion 22. Thus, to remove the light module 12 from the mounting portion 22, a user can pull the light module away from the mounting portion 22, causing the lip portion 181 to flex a sufficient amount away from the rear wall 182 to release the arcuate rearward rim portion 52 of the housing body member 42 and free the light module 12 from the mounting portion 22.

To install or reinstall the light module 12, a user may flex the rim portion 180 including the lip portion 181 thereof away from the rear wall 182 of the mounting portion 22 to expand the groove 184. The user may then work a portion of the arcuate rearward rim portion 52 of the housing body member 42 into the groove 184 such that the lip portion 181 extends over and retains the arcuate rearward rim portion 52 within the groove 184. The user may continue to work other portions of the arcuate rearward rim portion 52 into the groove 184 until the arcuate rearward rim portion 52 is fully received in the groove 184 about the entire periphery of the light module 12.

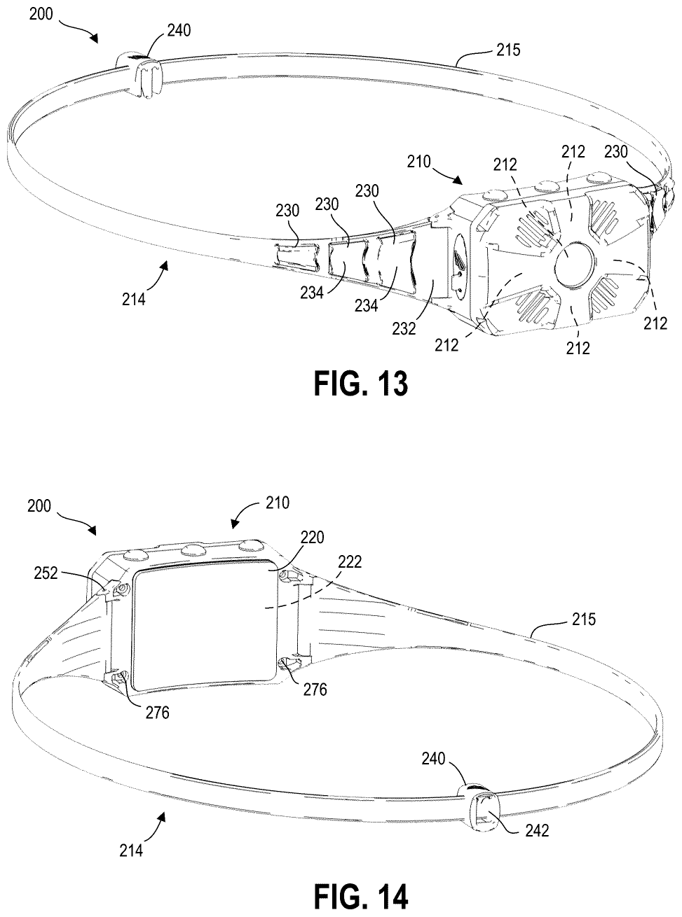

Referring to FIGS. 13 and 14, another example lighted headgear such as a headlamp 200 is shown. Headlamp 200 may be similar in many aspects to headlamp 10, and the discussion of headlamp 10 is incorporated with respect to headlamp 200 and vice versa. For example, headlamp 10 and headlamp 200 may include many of the same or similar components, and may function in similar manners.

Headlamp 200 includes a light module 210 having illumination sources 212, and a headband or head-fitting portion 214 for securing the light module 210 against a wearer's forehead. In this way, one or more illumination sources 212 of the light module 210 provide light forwardly and to the periphery of the wearer so as to illuminate an area in the wearer's field of view, as discussed in greater detail herein.

As shown in FIG. 14, the light module 210 may include a padding 220 on the rearwardly-facing surface of a rear wall 222 of the light module 210. The padding 220 provides a soft contact surface when the light module 210 is pressed against the wearer's forehead, and may be formed of a breathable material such as foam. In the approach shown, the padding 220 is generally free of discontinuities; though the padding 220 may optionally be provided with discontinuities such as raised ribs 32 discussed with respect to headlamp 10.

The head-fitting portion 214 may be in the form of a flexible, elastic strap or band 215 of resilient material, such as a polymeric material or elastomeric material (e.g., silicone) that is configured to be worn on skin. The band 215 has a narrow configuration while the light module 210 is wider to be enlarged relative thereto. As shown in FIG. 13, the band 215 may include one or more raised portions 230 on a generally forward-facing surface 232 of the band 215. The raised portions 230 may include concave surfaces 234 that provide a wearer improved grip of the band 215 when putting on, taking off, or adjusting the headlamp 200. The raised portions 230 may be integrally formed with the band 215 such that they are formed of the same material as the band 215.

The headlamp 200 may also include an adjustment mechanism 240 that allows a user to adjust the tension of the band 215 when the headlamp 200 is worn by a user. The adjustment mechanism 240 may be similar to adjustment mechanism 11 discussed in more detail with respect to FIG. 4. For example, a portion of the band 215 may be pulled through an opening 242 of the adjustment mechanism 240 for loosening its fit on a user's head.

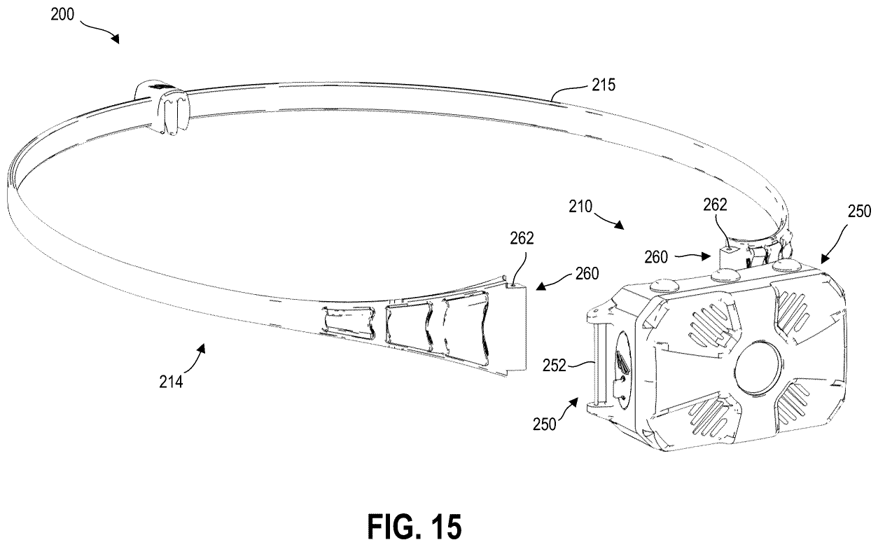

Referring to FIG. 15, the light module 210 is secured to the head-fitting portion 214 at opposite lateral sides 250 of the light module 210. For example, the light module 210 may include elongate pins 252 at the opposite lateral sides 250. The head-fitting portion 214 includes corresponding elongate apertures 262 at terminal end portions 260 of the head-fitting portion 214 that receive the pins 252 therein. In this way, opposite lateral sides 250 of the light module 210 are hingedly connected to the terminal end portions 260 of the head-fitting portion 214 as shown in FIGS. 13 and 14.

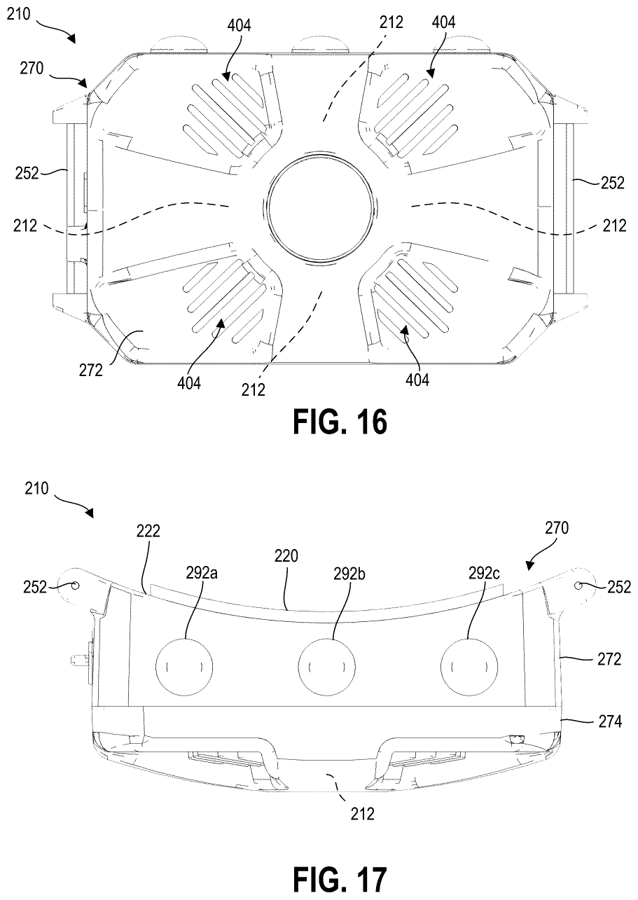

Referring to FIGS. 16-18, the light module 210 includes a housing assembly 270 that includes a housing body member 272 and a housing cover member 274 so that the housing assembly 270 has a two-part construction with the housing members 272 and 274 cooperating to enclose internal components of the light module 210 when the housing cover member 274 is secured to the housing body 272. The housing cover member 274 may be secured to the housing body member 272 with fasteners 276 (shown in FIG. 14) or other suitable securement approaches. The housing cover member 274 is preferably formed of a light transmissive material such as a transparent or translucent material such that light emitted from the illumination sources 212 passes therethrough, as will be discussed. The housing cover member 274 may be formed, for example, of a clear polycarbonate material.

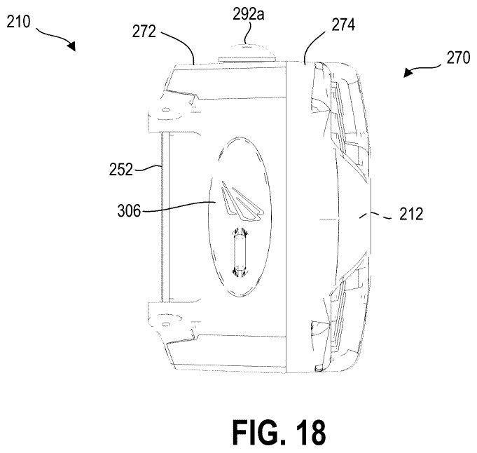

As shown in FIG. 17, the rear wall 222 of the housing body member 272 may be an arcuate rear wall 222 that has a curvature that is similar to the curvature of a forehead. This arcuate configuration of the rear wall 222 may provide improved feel for a wearer as compared to a light module having a planar rearward facing surface. The housing body member 272 may be formed of a rigid material such as acrylonitrile butadiene styrene (ABS) plastic. As discussed, the rear wall 222 may include a padding 220 that provides a soft contact surface when the light module 210 is pressed against the wearer's forehead.

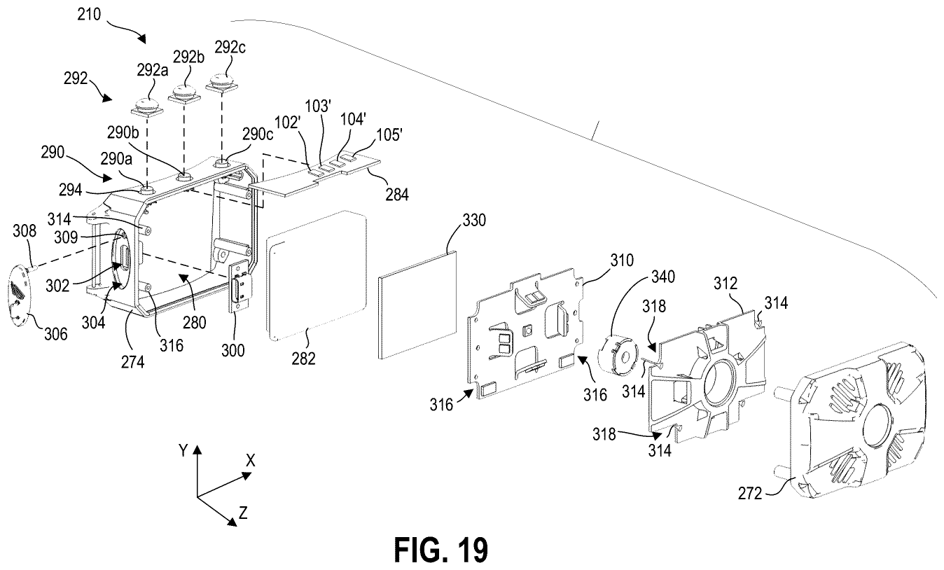

Referring to FIG. 19, the housing assembly 270 houses various internal components of the light module 210 within a cavity 280; for example, the illumination sources 212, a power source 282 for energizing the illumination sources 212, and a circuit board 284. The power source 282 may be a rechargeable power source such as a lithium battery (e.g., a 3.7 VDC 2000 mAh lithium polymer battery). Other power sources may be provided, as discussed with respect to power source 60 of headlamp 10.

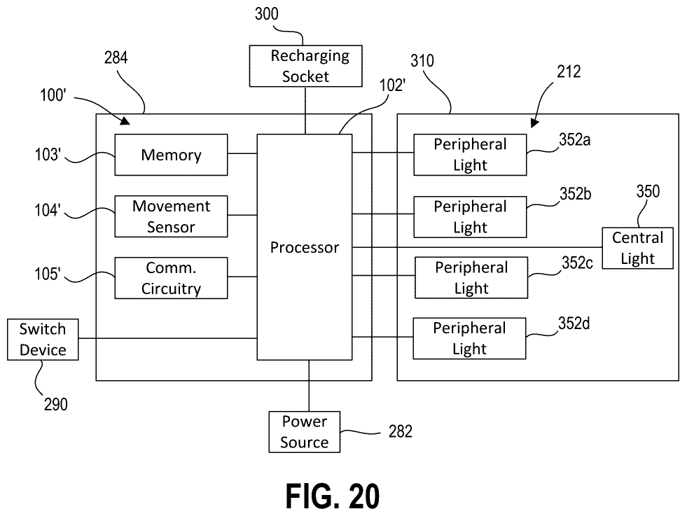

Referring to FIG. 20, the circuit board 284, which may be a printed circuit board (PCB), is electrically coupled to the power source 282 and the illumination sources 212 to control the operational state (e.g., on/off) and modes of the illumination sources 212 via a user-operated actuator, as described hereinafter. The circuit board 284 includes electrical circuitry 100′ that may generally correspond to the electrical circuitry 100 discussed with respect to the circuit board 62 of headlamp 10. For example, the communication circuitry 100′ may include one or more processors 102′, memories 103′, motion or movement sensor assemblies 104′, and communication circuitries 105′.

One or more switch devices 290 are coupled to the circuit board 284. The switch devices 290 may be push button or plunger-style switch devices, and may be normally-open momentary contact switches. Although three switch devices 290a, 290b, 290c are shown, a single switch device, two switch devices, or four or more switch devices may be provided. Other switch devices such as a slide switch, a toggle switch, or a rotary switch may be used instead of or in addition to switch devices 290.

As shown in FIG. 19, the switch covers 292 are aligned with and extend above the switch devices 290 and protrude through apertures 294 in the housing body member 272. The switch covers 292 may be resilient buttons formed, for example, of silicone. When a user presses on a switch cover 292a, 292b, 292c, the switch cover 292a, 292b, 292c actuates a corresponding switch device 290a, 290b, 290c to change a mode of the light module 210.

The light module 210 also includes a recharging socket 300 that is operably coupled to the power source 282 and that is configured to receive a charging plug for providing charging power for charging the power source 282. In one example, the recharging socket 300 is a 5 VDC/2A USB micro port that is capable of charging the power source 282 in approximately 3 hours. Other recharging ports may be provided that correspond to those discussed with respect to recharging socket 70 of headlamp 10.

To provide access to the recharging socket 300, the housing assembly 270 includes an access opening 302, an external recessed portion 304, and a cover or cap 306, which may correspond to the access opening 72, external recessed portion 74, and cap 80, respectively, of headlamp 10. The cap 306 may be removably secured relative to the housing body member 272. For example, an arm 308 of the cap 306 may be retained by an aperture 309 through the external recessed portion 304 of the housing body member 272 in a manner similar to the arm 82 of the cap 80.

The light module 210 further includes a light support 310 that supports the illumination sources 212. The light support 310 is a circuit board that facilitates operation of the illumination sources 212 and that also functions as a heat sink to dissipate heat emitted from the illumination sources 212. The light module 210 further includes a light reflector 312 that extends over the light support 310 and that guides light from the illumination sources 212 and through the housing cover member 274. The light module 210 further includes a lens member 340 that is received within the light reflector 312 and extends over an illumination source 212 for focusing light forwardly of the wearer. The interaction of the light support 310, light reflector 312, and lens member 340 are discussed in greater detail below.

The light module 210 includes fasteners 314 that secure the light support 310 and light reflector 312 to posts 316 of the housing cover member 274 at cutout regions 318, 320 of the light support 310 and light reflector 312, respectively. In one approach, an insert 330 is included between the power source 282 and the light support 310. The insert 330 may have a footprint that generally corresponds to one or both of the power source 282 and the light support 310 to insulate the light support 310 and components thereof from heat put off by the power source 282. The insert 330 also acts to bias the power source 282 against the rear wall 222 of the housing body member 272 to reduce “rattle” of the power source 282 inside the housing body member 272. The insert 330 may be formed, for example, of ethylene vinyl acetate (EVA).

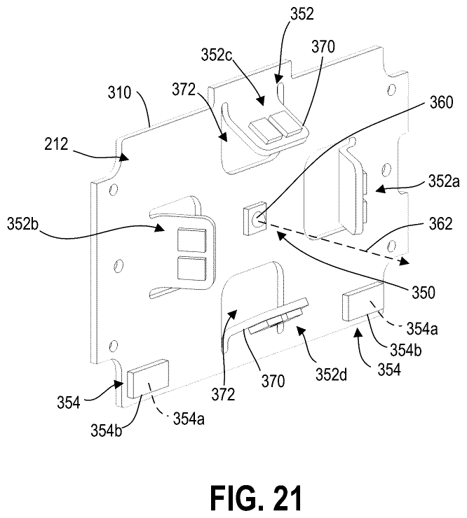

Referring to FIG. 21, the illumination sources 212 are supported on a common circuit board such as light support 310. The illumination sources 212 include a central light assembly 350, peripheral light assemblies 352, and one or more auxiliary light assemblies 354. The auxiliary light assemblies 354 include auxiliary LEDs 354a, which may emit light spreads of approximately 120-180 degree, and LED covers 354b that extend over to cover the auxiliary LEDs 354a. As shown in FIG. 21, the LED covers 354b may be in the form of flat-top LED covers. One or more of the auxiliary LEDs 354a may be color-changing LEDs. For example, each of the auxiliary LEDs 354a may be operable to switch between emitting red light, green light, or other color light. Green light emitted by the auxiliary LEDs 354a may assist users, for example, in certain low-light activities such as hunting (e.g., to track blood or to track animals that are unable to distinguish green light). Either green or red light emitted by the auxiliary LEDs 354a may be beneficial, for example, to read maps in low-light environments.

The central light assembly 350 includes a primary or central light source or LED 360 oriented to project light along central axis 362 thereof in a forward direction, to illuminate a front field of view of a user when in operation. With the light module 210 assembled, the lens member 340 extends over the central light assembly 350 to focus the light emitted from the central LED 360 to an approximately 60-degree spread or angle of view in front of the wearer. The central LED 360 may have a default or set mode of brightness that is brighter than the peripheral light assemblies 352 and one or more auxiliary light assemblies 354.

In the approach shown, each peripheral light assembly 352a, 352b, 352c, 352d includes two LEDs. The peripheral light assemblies 352 may be mounted on tabs 370 of the light support 310 that are bent or inclined away from the light support 310 to form gaps 372 that form oblique angles such that peripheral light assemblies 352 project light at an oblique angle outwardly away from the forward direction toward a peripheral direction. For example, the tabs 370 may be bent at an angle of approximately 30 degrees relative to a plane of the light support 310 that extends orthogonal to the central axis 362. As discussed herein, when a peripheral light assembly 352 is illuminated, light is projected by the peripheral light assembly 352 into the peripheral view of the wearer, thereby expanding the wearer's illuminated field of view, useful when encountering low lit or unlit environments

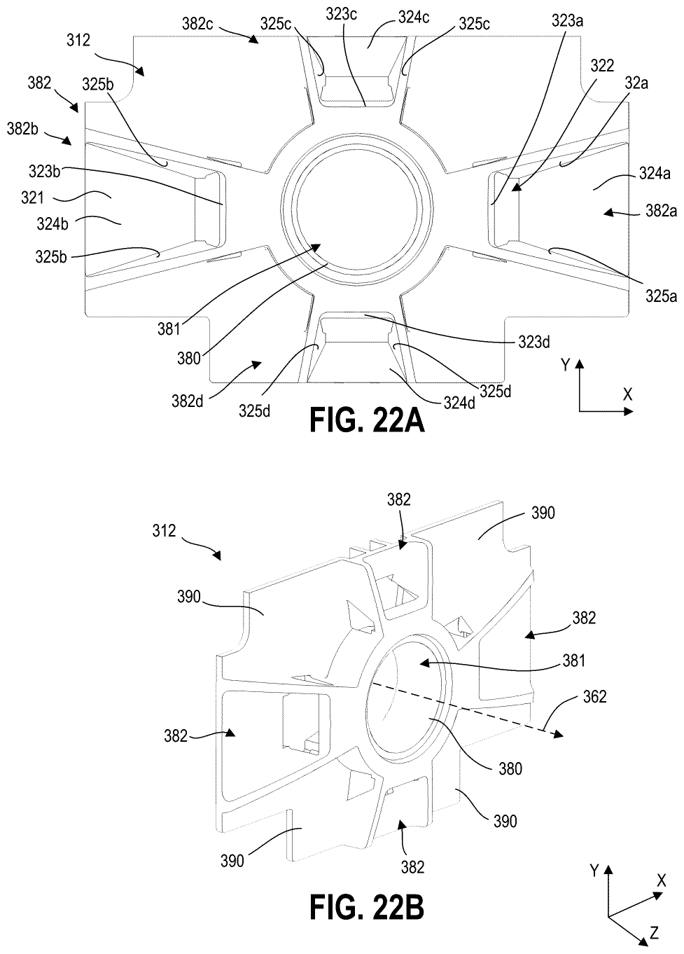

Referring to FIGS. 22A and 22B, light reflector 312 includes a central annular boss 380 that receives the lens member 340 of the central light assembly 350 so that the annular boss 380 is part of the central light assembly 350 and such that light emitted from the central LED 360 travels through a central opening 381 of the annular boss 380 of the light reflector 312 generally in the forward direction along central axis 362.

The light reflector 312 also includes peripheral light reflector portions 382 that extend radially from the central annular boss 380. The peripheral light reflector portions 382 are similar to peripheral petal portions 144 of the light reflector 140 of light module 12 of the headlamp 10 in many ways. For example, each peripheral light reflector portion 382 includes reflective surfaces or walls 321 that extend about an opening 322 that is aligned with respective peripheral light assemblies 352 to direct light from the peripheral light assemblies 352 in peripheral directions relative to central axis 362. More particularly, the lateral left and right reflector portions 382a, 382b have generally forwardly-directed radially inner reflector surfaces 323a, 323b, generally radially-directed outer reflector surfaces 324a, 324b, and opposing side surfaces 325a, 325b. Upper and lower reflector portions 382c and 382d have generally forwardly-directed radially inner reflector surfaces 323c, 323d and opposing side surfaces 325c, 325d. Upper reflector portion 382c has a generally upwardly-directed radially outer reflector surface 324c, and lower reflector portion 382d has a generally downwardly-directed radially outer reflector surface 324d.

The reflective walls 321 of the peripheral light reflector portions 382 are arranged to focus light in a manner similar to the walls 145 of light reflector 140. The geometries of walls 321 may differ in some aspects from the geometries of walls 145. For example, inner reflector surfaces 323a, 323b may have a reduced height relative to the inner reflector surfaces 160a, 160b, and may be canted or angled inwardly toward each other by approximately 55 degrees. Inner reflector surfaces 323c, 323d may similarly have a reduced height relative to the inner reflector surfaces 160c, 160d, and may be canted or angled inwardly toward each other by approximately 64 degrees.

Outer reflector surfaces 324a, 324b of the lateral left and right peripheral light reflector portions 382a, 382b may be generally flat (i.e., orthogonal to the central axis 362), or may have an incline of approximately 1 degree relative to the X-Y plane. The inclines of the outer reflector surfaces 324c, 324d of the upper and lower peripheral light reflector portions 382c, 382d are steeper (i.e., have a greater incline toward the Z axis) than the inclines of the outer reflector surfaces 382a, 382b of the lateral reflector portions 382a and 382b; for example, approximately 26 degrees relative to the X-Y plane. As previously explained, this difference is due to the human eye having reduced upward and downward peripheral vision as compared to the lateral peripheral vision of a human eye. As such, the outer reflector surfaces 382c, 382d of the upper and lower petal portions 382c and 382d may have a steeper incline to direct a greater amount of peripheral light generally forward of the wearer rather than upwardly.

Similar to the side surfaces 165a, 165b, 165c, 165d of light reflector 140, the side surfaces 325a, 325b, 325c, 325d of reflector portions 382 taper outwardly. For example, side surfaces 325a, 325b of the lateral left and right peripheral light reflector portions 382a, 382b may each taper outwardly at an angle of approximately 9 degrees relative to the X-Z plane. Side surfaces 325c, 325d of the upper and lower reflector portions 144c, 144d may each taper outwardly at an angle of approximately 4 degrees relative to the Y-Z plane. The side surfaces 325a, 325b, 325c, 325d also expand away from each other as they extend from the inner reflector surfaces 323a, 323b, 323c, 323d, as shown in FIG. 22A. In this way, when the processor 102 detects sufficient movement of the wearer's head in a lateral direction and activates either of peripheral light 352a or 352b, the side surfaces 325a, 325b focus light in the lateral direction and limit the vertical spread of light. Similarly, when the processor 102 detects sufficient movement of the wearer's head in an upward or downward direction and activates the corresponding peripheral light 352c, 352d, the side surfaces 165c, 165d focus light in the upward or downward direction and limit the lateral spread of light.

The light reflector 312 also includes web portions 390 that extend radially from the central annular boss 380 between adjacent peripheral light reflector portions 382. The web portions 390 extend over and cover corner regions of the light support 310.

The light reflector 312 may be formed, for example, of acrylonitrile butadiene styrene (ABS) plastic, and a forward facing surface of the light reflector 312 may be is coated (e.g., via electroplating) with a reflective material (e.g., silver, platinum, nickel, chrome, or combination thereof) that directs emitted light into the peripheral fields of view.

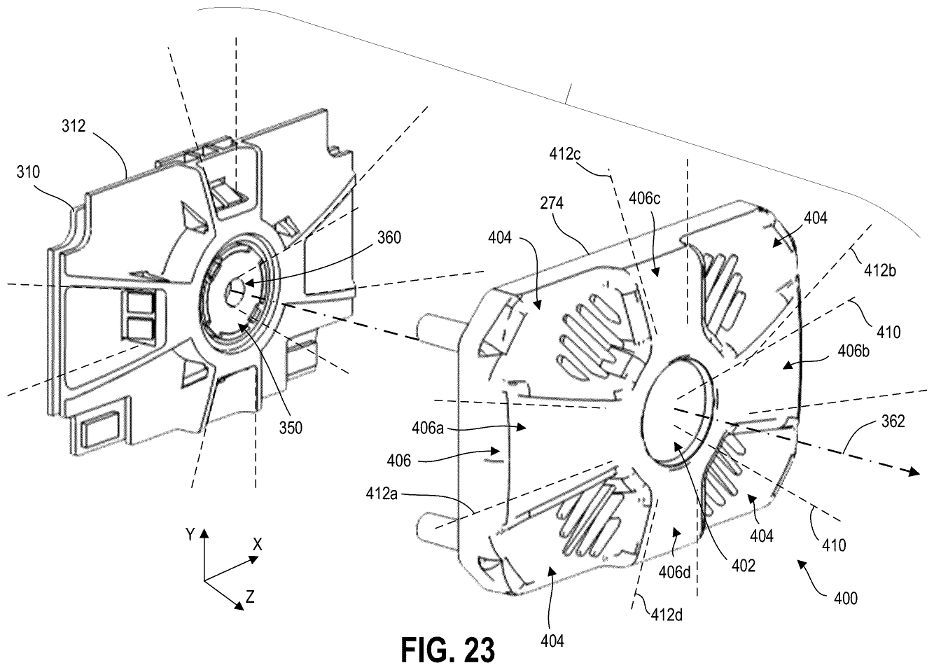

Referring to FIG. 23, the housing cover member 274 includes a forward-facing wall 400 that includes a central light emitting portion 402, generally flat recessed portions 404, and sloped wall portions 406 between the recessed portions 404. The central light emitting portion 402 may be recessed relative to the sloped wall portions 406 and is aligned with the central light assembly 350 such that light emitted from the central LED 360 passes through the light reflector 312 and generally forms central light spread 410 in the forward direction along central axis 362. Central light spread 410 may generally correspond to central light spread 120a discussed with respect to FIGS. 8-11.

The sloped wall portions 406 have a sufficient height and width to overlay and receive the peripheral light reflector portions 382 thereunder. In this way, with the housing cover member 274 secured over the assembly of the light support 310 and light reflector 312, the illumination sources 212 project light through the sloped wall portions 406 in peripheral directions relative to central axis 362. More particularly, right and left sloped wall portions 406a, 406b form right and left peripheral light spreads 412a, 412b (which may generally correspond to right and left peripheral light spreads 162a, 162b of FIGS. 8 and 10), and top and bottom sloped wall portions 406c, 406d form top and bottom peripheral light spreads 412c, 412d (which may generally correspond to top and bottom peripheral light spreads 162c, 162d of FIGS. 9 and 11).

As shown in FIG. 19, in one example approach, the light module 210 includes three switch devices 290a, 290b, 290c and corresponding switch covers 292a, 292b, 292c. Actuation of the first switch device 290a via the first switch cover 292a may control the light module 210 according to Table 3:

TABLE 3

| | Auxiliary | Center | Peripheral Light |
|---|---|---|---|
| | LEDs 354a | LED 360 | Assemblies 352a-d |
| First Actuation | ON | OFF | OFF |
| Second Actuation | OFF | ON - HIGH | ON - HIGH |
| Third Actuation | OFF | ON - MEDIUM | ON - MEDIUM |
| Fourth Actuation | OFF | ON - LOW | ON - LOW |
| Fifth Actuation | OFF | OFF | OFF |

As shown in Table 3, a first actuation of the first switch device 290a initiates an auxiliary-only mode in which one or more of the auxiliary LEDs 354a is illuminated. The auxiliary LEDs 354a may together emit red light, green light, or other color light. A second actuation of the first switch device 290a deactivates the auxiliary LEDs 354a and activates the center LED 360 and each of the peripheral light assemblies 352a, 352b, 352c, 352d in a “high intensity” mode to provide illumination in a forward direction and each of the right, left, upward, and downward peripheral directions. Successive third and fourth actuations of the first switch device 290a switch the center LED 360 and peripheral light assemblies 352a, 352b, 352c, 352d to “medium intensity” and “low intensity” modes, respectively. A fifth actuation of the first switch device 290a deactivates the center LED 360 and peripheral light assemblies 352a, 352b, 352c, 352d to put the light module 210 in an “off” mode.

Actuation of the second switch device 290b via the second switch cover 292b may control the light module 210 according to Table 4:

TABLE 4

| | | Peripheral Light |
|---|---|---|
| | Center LED 360 | Assemblies 352a-d |
| First Actuation | ON | ADAPTIVE MODE |
| Second Actuation | ON | OFF |
| Third Actuation | ON | ON |

In the “adaptive mode,” center LED 360 is activated and peripheral lights 352 are selectively activated based on detected movement of the light module 210 toward a peripheral direction of the wearer, as discussed herein. A second actuation of the second switch device 290b changes the mode to a “center only” mode in which the center LED 360 is activated and the peripheral light assemblies 352a, 352b, 352c, 352d do not activate, even upon detected movement in a peripheral direction. A third actuation of the second switch device 290b changes the mode to an “all on” mode in which the center LED 360 and the peripheral light assemblies 352a, 352b, 352c, 352d are all activated.

With the light module 210 in the “adaptive mode” of Table 4, a wearer may actuate the third switch device 290c via the third switch cover 292c to adjust the sensitivity with which the processor activates a peripheral light 352 based on motion or movement detected by the motion or movement sensor assemblies 104′. For example, as a user successively actuates the third switch device 290c, the light module 210 may cycle through a “high sensitivity” adaptive mode, a “medium sensitivity” adaptive mode, and a “low sensitivity” adaptive mode. A wearer may decide to adjust the sensitivity based on the wearer's activity. For example, during a running activity during which a wearer may frequently and rapidly turn their head, the wearer may choose to operate the light module 210 in a “low sensitivity” adaptive mode. In this mode, the threshold for activating a peripheral light assembly 352 is highest relative to other modes such that the peripheral light assemblies 352 are activated less frequently for a detected movement. During a walking activity during which a wearer may turn their head less frequently, the wearer may choose to operate the light module 210 in a “high sensitivity” adaptive mode. In this mode, the threshold for activating a peripheral light assembly 352 is lowest relative to other modes such that the peripheral light assemblies 352 are activated more frequently for a detected movement. During an activity such as cycling, the wearer may choose to operate the light module 210 in a “medium sensitivity” adaptive mode. In this mode, the threshold for activating a peripheral light assembly 352 is lower than that of the “high sensitivity” adaptive mode and higher than that of the “low sensitivity” adaptive mode.

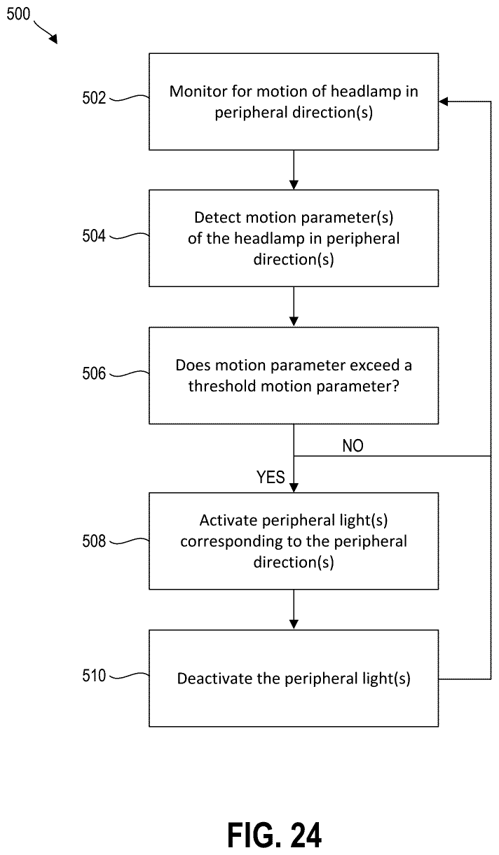

Referring now to FIG. 24, a method 500 of controlling one or more peripheral lights of a headlamp is shown. The peripheral lights may include, for example, one or more laterally-left peripheral lights, one or more laterally-right peripheral lights, one or more upwardly-directed peripheral lights, and one or more downwardly-directed peripheral lights. As discussed, the headlamp may also include one or more forwardly-directed primary lights.

The method 500 includes monitoring 502, at a movement sensor, for motion of the headlamp in at least one peripheral direction. The method 500 further includes detecting 504, at the movement sensor, a motion parameter of the headlamp in at least one peripheral direction. The motion parameter may include an orientation (including a static orientation and/or a change in orientation), acceleration, speed, and location (including a static location and/or a change in location) of the headlamp.

The method 500 further includes determining 506, at a processor, whether the detected motion parameter exceeds a threshold motion parameter. If the detected motion parameter does not exceed a threshold motion parameter, the method 500 returns to monitoring 502 for motion of the headlamp in at least one peripheral direction.

If the detected motion parameter does exceed a threshold motion parameter, the method 500 includes activating 508 at least one peripheral light corresponding to the at least one peripheral direction. In some examples, the method 500 includes activating a plurality of peripheral lights corresponding to motion detected in a plurality of peripheral directions.

The method 500 further includes deactivating 510 one or more activated peripheral lights, whereafter the method 500 returns to monitoring 502 for motion of the headlamp in at least one peripheral direction. In one approach, a peripheral light may be deactivated after expiration of a predetermined time. In another approach, a peripheral light may be deactivated upon determination that the motion parameter no longer exceeds the threshold motion parameter.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A dynamically activated headlamp for being worn on a user's head, the dynamically activated headlamp comprising:
a light module;
a primary light source of the light module for directing light in a forward direction relative to the user's head;
a plurality of peripheral light sources of the light module arranged about a periphery of the primary light source for directing light in corresponding peripheral directions relative to the user's head;
a motion sensor configured to detect movement of the user's head; and
a controller configured to:
automatically activate one or more of the peripheral light sources in response to movement of the user's head detected by the motion sensor when the detected movement meets a predetermined light activation parameter, and
automatically deactivate the one or more peripheral light sources in response to detection of a predetermined light deactivation parameter.

2. The dynamically activated headlamp of claim 1, wherein the primary light source is a central light source and the plurality of peripheral light sources includes a lateral light source laterally adjacent to the central light source and a vertical light source either above or below the central light source, with the controller being configured to activate both the lateral light source and vertical light source in response to the motion sensor detecting a directional motion including both corresponding lateral and vertical components of movement.

3. The dynamically activated headlamp of claim 1, wherein the plurality of peripheral light sources includes a first light source laterally on a first side of the primary light source, a second light source laterally on a second side of the primary light source opposite the first light source, a third light source above the primary light source, and a fourth light source below the primary light source opposite the third light source.

4. The dynamically activated headlamp of claim 1, wherein the plurality of peripheral light sources includes a first plurality of light sources laterally on a first side of the primary light source, a second plurality of light sources laterally on a second side of the primary light source opposite the first plurality of light sources, a third plurality of light sources above the primary light source, and a fourth plurality of light sources below the primary light source opposite the third plurality of light sources.

5. The dynamically activated headlamp of claim 1, wherein the motion sensor includes a gyroscope for detecting a direction of movement of the user's head.

6. The dynamically activated headlamp of claim 1, further comprising an auxiliary light source spaced from the primary light source and the plurality of peripheral light sources, wherein the controller is configured to allow the user to selectively operate the auxiliary light source while the primary and peripheral light sources are inactive.

7. The dynamically activated headlamp of claim 1, further comprising a user interface for selecting an operating mode from a plurality of operating modes with individual ones of the of the plurality of operating modes having different light activation parameter thresholds from other ones of the plurality of operating modes.

8. The dynamically activated headlamp of claim 1, wherein the light activation parameters include a plurality of user-selectable light activation parameters including a first motion sensitivity and a second motion sensitivity different than the first motion sensitivity.

9. The dynamically activated headlamp of claim 1, wherein the primary light source is a central light source that directs light in the forward direction along a central axis, and the plurality of peripheral light sources are oriented to direct light at an angle oblique from the central axis of central light source.

10. The dynamically activated headlamp of claim 1, wherein the primary light source has a first luminance and the plurality of peripheral light sources have a second luminance less than the first luminance.

11. The dynamically activated headlamp of claim 1, wherein the light activation parameter includes a threshold acceleration parameter.

12. The dynamically activated headlamp of claim 1, wherein the light activation parameter includes a threshold acceleration or above for a predetermined time parameter.

13. The dynamically activated headlamp of claim 1, wherein the controller is configured to automatically deactivate a first peripheral light source of the plurality of peripheral light sources in response to detecting a deactivation parameter and maintain activation of a second peripheral light source of the peripheral light sources after detecting the deactivation parameter.

14. The dynamically activated headlamp of claim 1, wherein the controller is configured to maintain activation of the primary light source during each of selective activation and deactivation of the one or more of the peripheral light sources responsive to movement of the user's head as detected by the motion sensor.

15. The dynamically activated headlamp of claim 1, wherein the controller is configured to deactivate the one or more peripheral light sources after expiration of a predetermined time.

16. The dynamically activated headlamp of claim 1, wherein the controller is configured to deactivate the one or more peripheral light sources after the light activation parameter is no longer met.

17. The dynamically activated headlamp of claim 1, further comprising communication circuitry including a global positioning system (GPS) in communication with the controller, the controller configured to activate one or more of the peripheral light sources in response to positioning information received from the GPS.

18. A method of controlling lights of a dynamically activated headlamp worn by a user, the method comprising:
energizing a primary light source to direct light in a forward direction forwardly of the user:
monitoring for motion of the headlamp in at least one peripheral direction;
detecting a motion parameter of the headlamp in the at least one peripheral direction;
determining whether the detected motion parameter exceeds a threshold of the motion parameter; and
activating at least one peripheral light at at least one peripheral side of the primary light source corresponding to the at least one peripheral direction to direct light in the corresponding at least one peripheral direction.

19. The method of claim 18, wherein the primary light source is a central light source and the least one peripheral light includes a lateral light source laterally adjacent to the central light source and a vertical light source either above or below the central light source.

20. The method of claim 18, wherein the motion parameter includes a threshold acceleration parameter.
